(19) United States
(12) Patent Application Publication
(10) Pub. No.: US 2009/0190775 A1
(43) Pub. Date: Jul. 30, 2009

(54) MICROPHONE ARRANGEMENT COMPRISING PRESSURE GRADIENT TRANSDUCERS

(76) Inventor: Friedrich Reining, Vienna (AT)

Correspondence Address: HARMAN - BRINKS HOFER CHICAGO;Brinks Hofer Gilson & Lione, P.O. Box 10395, Chicago, IL, 60610, US

(21) Appl. No.: 12/390,990

(22) Filed: Feb. 23, 2009

(30) Foreign Application Priority Data
Nov. 13, 2007 (AT) PCT/AT2007/000513

(51) Int. Cl. H04R 3/00

(52) U.S. Cl. 381/92

(57) ABSTRACT

A microphone arrangement includes pressure gradient transducers that include a diaphragm. Each pressure gradient transducer has a first sound inlet opening that leads to a front portion of the diaphragm and a second sound inlet opening that leads to a back portion of the diaphragm. The directional characteristic of each pressure gradient transducer includes an omni portion, a figure-eight portion, and a direction of maximum sensitivity in a main direction. The acoustic centers of the pressure gradient transducers lie within an imaginary sphere having a radius corresponding to about double the largest dimension of the diaphragm. Projections of the main directions of the pressure gradient transducers form angles between about 110° and about 130° in a base plane.

### 1. PRIORITY CLAIM

This application claims the benefit of priority from PCT/AT2007/000513, filed Nov. 13, 2007, which is incorporated by reference.

### BACKGROUND OF THE INVENTION

1. Technical Field

This disclosure relates to a microphone arrangement, or more particularly to a system that synthesizes one or more microphone signals.

2. Related Art

A coincident arrangement of gradient transducers may form a soundfield microphone (or B-format microphone). A soundfield microphone includes four pressure gradient capsules. The individual capsules are arranged in a tetrahedral form with the diaphragms of the individual capsules parallel to the imaginary surfaces of a tetrahedron. Each pressure gradient receivers delivers signals A, B, C or D and has a directional characteristic deviating from a sphere. The characteristic may be represented by k+(1−k)×cos(θ). θ denotes the azimuth, under which the capsule is exposed to sound. k indicates a percentage of omni signal (in a sphere, k=1, in a figure-of-eight, k=0). The signals of the individual capsules maybe denoted A, B, C and D. The axis of symmetry of directional characteristic of each individual microphone is perpendicular to the diaphragm and to the corresponding surface of the tetrahedron. The axes of symmetry of the directional characteristic of each individual capsule may form an angle of about 109.5° with each other.

According to one calculation, the four individual capsule signals maybe converted into a B-format (W, X, Y, Z):

W=½(A+B+C+D)

X=½(A+B−C−D)

Y=½(−A+B+C−D)

Z=±½(−A+B−C+D)

The forming signals may form a sphere (W) and three figure-eights (X, Y, Z) that are orthogonal to each other. To configure the frequency and phase response of the directions, so that a flat energy characteristic is achieved with respect to the frequencies in the audible range, the signals W, X, Y, Z may be equalized. For a zero-order signal (W) and the first-order signals X, Y, Z, theoretical equalization characteristics depend on the frequency and effective distance of the center of the microphone capsules from the center of the tetrahedron.

The main directions of the figure-eight X, Y, Z are normal to the sides of a cube enclosing the tetrahedron. By linear combination of at least two of these B-format signals, an arbitrary microphone capsule may be synthesized. Deviations from the theory based on the use of real capsules and the failure to satisfy ideally the coincidence requirement cause the performance of the synthesized microphones to deteriorate.

Synthesizing or modeling of the microphone may occur precisely in that the omni signal W is combined with one or more of the signals X, Y, Z, taking into account a linear weighting factor “r”. For directional characteristics in the area between a sphere and a cardioid, this may be derived for a synthesized capsule in the X-direction through the formula M=W+r×X, in which r can assume arbitrary values >0. The level of the signal M obtained may be normalized, so that the desired frequency trend is obtained for the main direction of the synthesized capsule. If a synthesized capsule is analyzed in any direction, additional weighting factors may be used, since rotation of the synthesized capsule in any direction may occur through a linear combination of three orthogonal figure-eights (X, Y, Z).

In a soundfield microphone the directional characteristic of the entire microphone may be adjusted. The microphone may be adapted even during playback or a final production of a sound carrier. It is possible to focus on a corresponding soloist of an ensemble, to mask out unexpected and undesired sound events by influencing the directional characteristic, or to follow a moving sound source (for example, a performer on the stage), so that the recording quality remains independent of the changed position of the sound source.

When sound is recorded from a soundfield microphone, the entire sound field may be described at any location in time. Time differences, etc., may be analyzed during selected evaluations. When deviations occur, the coincidence conditions for small wavelengths may no longer be satisfied. Distortions and artifacts may occur with respect to the frequency response and directional characteristic of a synthesized signal. A rotation of each individual gradient capsule of the soundfield microphone of about 180°, so that each of the four diaphragm surfaces is brought closer to the center, has shown that artifacts may not be eliminated at higher frequencies. Acoustic shadowing of the front microphone mouthpieces may not alter the limit frequency, up to which the calculation method applies.

There is a trade-off between the coincidence requirement and the attainable noise distance of the employed gradient capsules. The larger the individual diaphragm surface, the more noise distance may be achieved. However, this relationship leads to a larger distance of the diaphragm surfaces to the center of the arrangement. An optimal solution requires positioning of the four individual capsules as closely as possible to each other, so that the sound inlet on the back of the gradient transducer is influenced by the resulting structure of the closely positioned capsules. This means that the cavity formed in the interior of the microphone arrangement, and naturally also its delimitation by the microphone arrangement, as well as its mounts, etc., will act as an acoustic filter. The acoustic filter may affect the acoustic filtering by the sound paths that lead to the back of the individual capsules. The effect of this additional acoustic filter is frequency-dependent and may have its strongest effect at frequencies at which the wavelength of the sound is about the same order as the dimensions of the diaphragm or the dimensions of the entire soundfield microphone. In some soundfield microphones, this effect may occur in the frequency range around 10 kHz, at which rejection, (e.g., the frequency response from the direction from which the individual capsule is least sensitive becomes weakest and, drops below 10 dB).

In some soundfield microphones, two of the capsules may be situated with their main direction positioned downward, which means that they may be particularly sensitive to non-ideal microphone mounting or fastening under practical conditions. Such acoustic disturbances, based on the capsule arrangement, may develop due to reflections on the mounting material, on the floor, etc. In addition, the capsules in the close arrangement may be influenced when the theoretically rotationally symmetric directional characteristic of the synthesized omni signal is disturbed.

In some soundfield microphones a common configuration (X-Y-plane) is achieved by switching four capsule signals. The B-format signals in the X-Y-plane may be formed from microphone signals that meet at an angle of about 54° in each capsule under the influence of sound. If a directional diagram of a gradient transducer is considered, scattering of the rejection angle of the individual capsules may have a stronger effect, as the inlet direction deviates from the main direction. If two capsules with slightly different polar patterns exposed to sound from 0° differ only by the sensitivity described, at angles greater than 0°, the difference is increased by a percentage as a result of the difference in rejection angles.

### SUMMARY

A microphone arrangement includes pressure gradient transducers that include a diaphragm. Each pressure gradient transducer has a first sound inlet opening that leads to a front portion of the diaphragm and a second sound inlet opening that leads to a back portion of the diaphragm. The directional characteristic of each pressure gradient transducer includes an omni portion, a figure-eight portion, and a direction of maximum sensitivity in a main direction. The acoustic centers of the pressure gradient transducers lie within an imaginary sphere having a radius corresponding to about double the largest dimension of the diaphragm. Projections of the main directions of the pressure gradient transducers form angles between about 110° and about 130° in a base plane.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a microphone arrangement.

FIG. 2 shows an alternative to the microphone arrangement.

FIG. 3 shows another alternative with the pressure gradient capsules within a common housing.

FIG. 4 show the arrangement at a boundary.

FIG. 5 show another arrangement at a boundary.

FIG. 6 shows another alternative arrangement.

FIG. 7 shows an alternative in which the gradient capsules of FIG. 6 are embedded within a boundary.

FIG. 8 shows a gradient transducer with sound inlet openings on opposite sides of the capsule housing.

FIG. 9 shows a gradient transducer with sound inlet openings on the same side of the capsule housing.

FIG. 10 shows the directional characteristic of the individual gradient transducers from the z-direction.

FIG. 11 shows the directional characteristics from the y-direction.

FIG. 12 shows a sectional view of the microphone arrangement of the four gradient transducers along line I-I of FIG. 13.

FIG. 13 shows the top view of the microphone arrangement of FIG. 12.

FIG. 14 shows the directional characteristics of the gradient transducer of FIG. 12 from the y-direction.

FIG. 15 shows a block diagram that produces B-format signals.

FIG. 16 shows a block diagram of the expanded signal processing unit.

FIG. 17 shows FIG. 16 with directional characteristics.

FIG. 18 shows the spectral subtraction unit in detail.

FIG. 19 shows a simplified circuit.

FIG. 20 is a schematic concept of coincidence.

### DETAILED DESCRIPTION OF THE PREFERRED EMBODIMENTS

A microphone arrangement converts individual transducer signals into a B-format. Coincidence may be ensured or improved. Shadowing effects that may arise when the individual capsules shade each other may be reduced or substantially attenuated. Acoustic disturbances from spatial conditions near the microphone arrangement and the dependence on capsule tolerances (for example, deviations in the manufacturing process) may be minimized. In some microphone arrangements, the acoustic centers of the three pressure gradient transducers may lie within an imaginary sphere having a radius correspond to about double the largest dimension of the diaphragm of a pressure gradient transducer. The projections of the main directions of the three pressure gradient transducers in a base plane spanned by first sound inlet openings of the three pressure gradient transducers enclose an angle. The angle may lie between about 110° and about 130°. Coincidence may increase by moving the sound inlet openings together.

“Synthesized directional characteristic” is a combination of individual B-format signals, for example, a sphere (W) with at least one additional B-format signal (a figure-eight), and also their further processing, such as equalization, bundling, rotation, etc. The individual signals may be processed with a corresponding weighting.

The expression “directional characteristic” is not only the directional characteristic of the real capsules, but of signals in general. These signals may be comprised of other signals (for example, B-format signals) and have complicated multiple directional characteristics. If such directional characteristics may not be achieved with individual capsules, the expression “directional characteristic” is used to establish from which spatial areas the formed or synthesized signals preferably yield acoustic information.

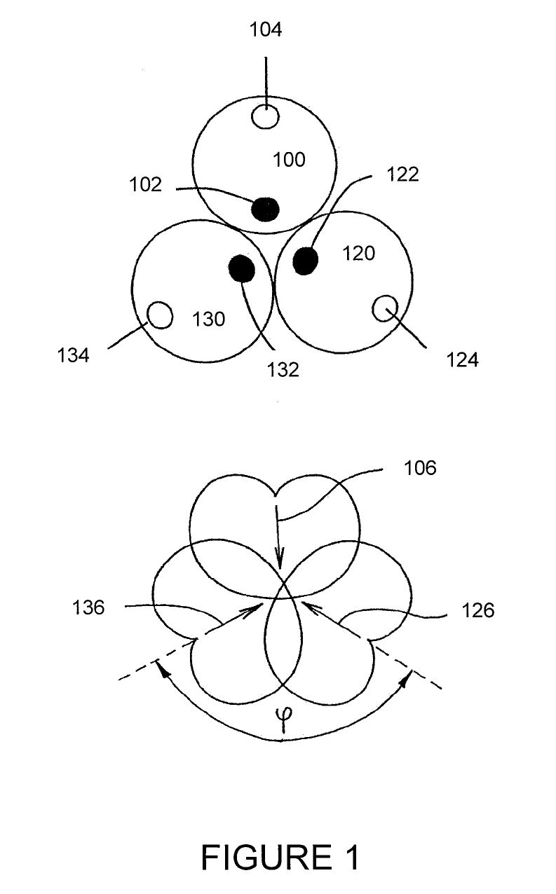

FIG. 1 is a microphone arrangement comprising three pressure gradient transducers 100, 120, 130. The directional characteristic of each transducer may include an omni portion and a figure-eight portion (e.g., bi-directional). The directional characteristic may be represented as P(θ)=k+(1−k)×cos(θ), in which k denotes the angle-independent omni portion and (1−k)×cos(θ) denotes the angle-dependent figure-eight portion. In the lower portion of FIG. 1, the microphone arrangements may include gradient transducers that generate cardioid characteristics. In alternative arrangements other characteristics are generated. The characteristics may be rendered from a combination of an omni and figure-eight characteristics such as hypercardioids, supercardioid, shotgun, etc.

The gradient transducers 100, 120, 130 of FIG. 1 lie in an x-y-plane, in which their main directions 106, 126, 136—the directions of their maximum sensitivity—are inclined relative to each other by the azimuth angle φ. The angle φ, between two main directions, may be between about 110° and about 130°, but preferably about 120°. In alternative systems, any type of gradient device that converts one form of energy to another (e.g. acoustic-to-electric) may be used. The systems may include a flat transducer or boundary microphone, in which the two sound inlet openings lie on the same side surface, e.g., boundary.

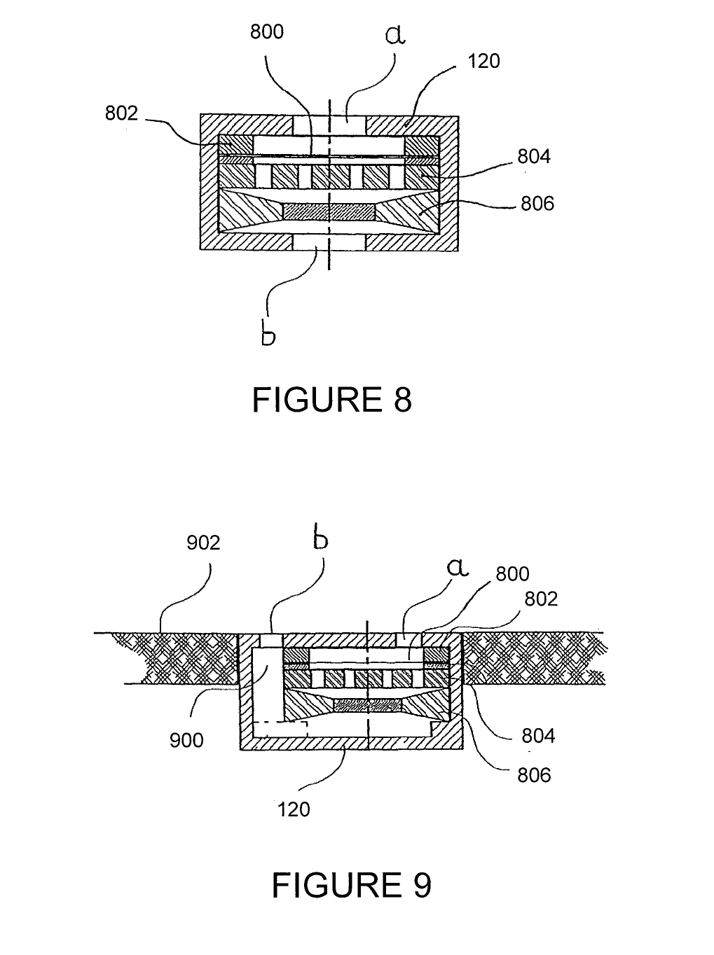

FIG. 8 and FIG. 9 show the difference between a “normal” gradient capsule and a “flat” gradient capsule. In FIG. 8, a sound inlet opening “a” is situated on the front of the capsule housing 1200 and a second sound inlet opening “b” is situated on the opposite back side of the capsule housing 1200. The front sound inlet opening “a” is connected to the front of diaphragm 800, which is tightened through a diaphragm ring 802, and the back sound inlet opening “b” is connected to the back of diaphragm 800. An acoustic friction element 806 (e.g., a non-woven material or element, foam, etc.) may be positioned behind electrode 804.

In the flat gradient capsule of FIG. 9, (e.g., a boundary microphone) sound inlet openings a, b are positioned on the front of the capsule housing 1200, in which one leads to the front of diaphragm 800 and the other leads to the back of diaphragm 800 through a sound channel 900. The transducer may be incorporated in a boundary such as a console of a vehicle, for example. The acoustic friction element 806 may comprise a non-woven material, a foam, constrictions, perforated plates, etc., that may be arranged in the area near or adjacent to diaphragm 800 in a substantially flat design.

By arranging inlet openings a, b on one side of the capsule, a directional characteristic asymmetric to the diaphragm axis may be generated (e.g., cardioid, hypercardioid, etc.) The capsules may include characteristics described in EP 1 351 549 A2 and U.S. Pat. No. 6,885,751 A, which are incorporated by reference. In some capsules, the front of the diaphragm comprises a side that may be reached relatively unhampered by sound. The back of the diaphragm may be reached after passing through an acoustically phase-rotating element by the sound. In these arrangements the sound path to the front may be shorter than the sound path to the rear.

In FIG. 1, the three gradient capsules 100, 120, 130 are oriented toward each other. The sound inlet openings 102, 122, 132 leading to the front of the corresponding diaphragm lie adjacent or very near each other and the sound inlet openings 104, 124, 134 leading to the back of the diaphragm lie on the periphery of the arrangement. The point of intersection of the lengthened connection lines that join the front sound inlet opening 102, 122, and 132 to the rear sound inlet opening 104, 124 and 134 is viewed as the center of the microphone arrangement. The front sound inlet openings 102, 122, 133 of the three transducers 100, 120, 130, or mouth pieces, are positioned in the center area of the arrangement. The coincidence of the transducers may be strongly influenced (or increased) by this arrangement.

The coincidence may occur due to the acoustic centers of the gradient transducers 100, 120, and 130 that may be positioned close together. In some arrangements the center may occur at a common point. The acoustic center of a reciprocal transducer may be the point from which omni waves seem to be diverging when the transducer is acting as a sound source. “A note on the concept of acoustic center”, by Jacobsen, Finn; Barrera Figueroa, Salvador; Rasmussen, Knud; Acoustical Society of America Journal, Volume 115, Issue 4, pp. 1468-1473 (2004), which is incorporated by reference, examines ways of determining the acoustic center of a source, including methods based on deviations from the inverse distance law and methods based on the phase response. “The acoustic center of laboratory standard microphones” by Salvador Barrera-Figueroa and Knud Rasmussen; The Journal of the Acoustical Society of America, Volume 120, Issue 5, pp. 2668-2675 (2006), which is also incorporated by reference, describes how acoustic centers may be identified.

The acoustic center may also be determined by measuring spherical wave fronts during sinusoidal excitation of the acoustic transducer. The measurement may occur at a selected frequency in a selected direction and at a certain distance from the transducer in a small spatial area. The area may be an observation point. Analysis of the spherical wave fronts may identify the center of the omni wave or the acoustic center.

For a reciprocal transducer, such as a condenser microphone, the transducer may be utilized as a sound emitter or sound receiver. The acoustic center may be identified by:

$$p ( r ) = j \frac{ρ * f}{2 * {r}_{t}} {M}_{f} * i * {e}^{- γ * {r}_{t}} \qquad ( 1 )$$

rₜ . . . Acoustic center

ρ . . . Density of air

f . . . Frequency

M_{f} . . . Microphone sensitivity

i . . . Current

γ . . . Complex wave propagation coefficient

In a pressure receiver exclusively, the center may comprise average frequencies (in the range of about 1 kHz), that may deviate at high frequencies. The acoustic center of a pressure receiver may occur in a small area. To determine the acoustic center of gradient transducers, a different approach is used, since formula (I) does not consider the near-field-specific dependences. The location of an acoustic center may be identified by locating the point in which a transducer must be rotated to observe the same phase of the wavefront at the observation point.

In a gradient transducer, an acoustic center may be identified through a rotational symmetry. The acoustic center may be positioned on a line normal to the diaphragm plane. The center position on the line may be determined by two measurements: at a point most favorably from the main direction, about 0°, and at point of about 180°. In addition to the phase responses of these measurements, for an average estimate of the acoustic center the rotation point around which the transducer is rotated between measurements, may be changed in the time domain. The adjustment may ensure that the impulse responses are maximally congruent (e.g., the maximum correlation between the two impulse responses lies in the center).

In some microphone arrangements, in which the two sound inlet openings are situated on a boundary, the acoustic center is not the diaphragm center. The acoustic center may lie closest to the sound inlet opening that leads to the front of the diaphragm. This forms the shortest connection between the boundary and the diaphragm. In other arrangements, the acoustic center may lie outside of the capsule.

The coincidence criterion may require, that the acoustic centers 2002, 2022, and 2032 of the pressure gradient capsules 100, 120, and 130 to lie within an imaginary sphere O, whose radius R is double (or about double) the largest dimension D of the diaphragm of a transducer. In alternative systems the acoustic centers of the pressure gradient transducers may lie within an imaginary sphere having radius corresponding to the largest dimension of the diaphragm of a transducer. By increasing the coincidence through movement of the sound inlet openings together improved performance may occur.

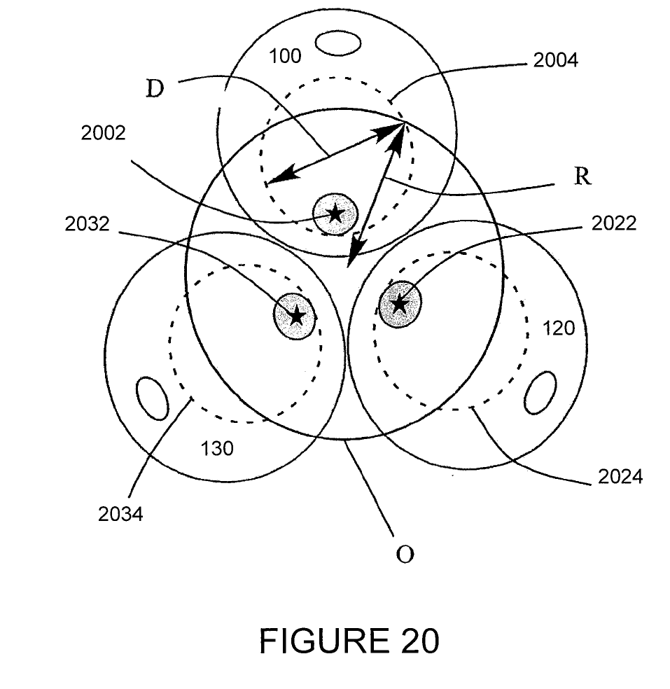

To ensure a coincidence condition, the acoustic centers 2002, 2022, 2032 of the pressure gradient capsules 100, 120, and 130 of FIG. 20 lie within an imaginary sphere O, having a radius R is equal to (or about equal to) the largest dimension D of the diaphragm of a transducer. The size and position of the diaphragms 2004, 2024, 2034, are indicated in FIG. 20 by dashed lines. In an alternative, this coincidence condition may also be established in that the first sound inlet openings 102, 122, 132 that lie within an imaginary sphere whose radius is smaller than the largest dimension of the diaphragm in the pressure gradient transducer. Since the size of the diaphragm determines the noise distance and therefore represents a direct criterion for designing the acoustic geometry, the largest diaphragm dimension (for example, the diameter of a round diaphragm, or a side length in a triangular or rectangular diaphragm) may determine the coincidence conditions. In some systems diaphragms 2004, 2024, 2034, may not have the same dimension. In these systems, the largest diaphragm may be used to determine the preferred criterion.

In the microphone arrangement shown in FIG. 1, the three gradient transducers 100, 120, and 130 are arranged in a plane. The connection lines of the individual transducers, which connect the front and rear sound inlet openings to each other, are inclined with respect to each other by an angle of about 120°. The front sound inlet openings lie on the corners of a preferably equilateral triangle. The rear sound inlet openings also lie on the corners of an external, preferably equilateral triangle. This arrangement of three gradient transducers may render an improved coincidence.

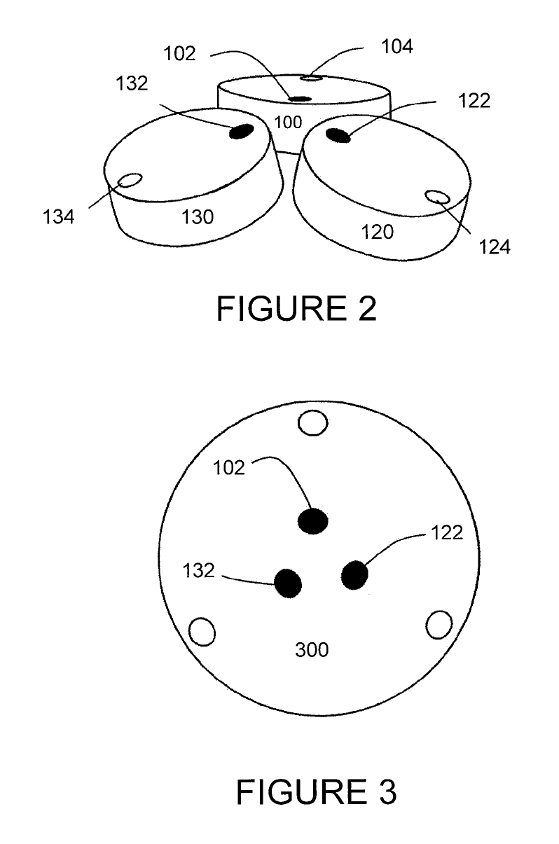

FIG. 2 shows an alternative microphone arrangement, in which the gradient capsules are not arranged in a plane, but on an imaginary omni surface. The microphone arrangement may be arranged on a curved boundary like the console of a vehicle, for example.

In a curvature arrangement, the distance to the center is reduced (which is desirable, because the acoustic centers lie closer together), and the mouthpiece openings may be somewhat shaded. A curved arrangement may alter the directional characteristic of the individual capsules to the extent that a figure-eight portion of the signal becomes smaller (from a hypercardioid, then a cardioid). To minimize the adverse effect of shadowing, the curvature may be limited (e.g., not to exceed about 60°). The capsules may be positioned on the outer surface of an imaginary cone whose surface line encloses an angle of at least 30° with the cone axis.

The sound inlet openings 102, 122, 132 that lead to the front of the diaphragm may lie in a plane, referred to as base plane. The sound inlet openings 104, 124, 134 may lie outside of this plane. The main directions of the individual gradient transducers 100, 120, 130 each enclose an angle of about 120° with respect to each other. This orientation of the main directions may represent a preferred alternative. Deviations from the 120° arrangement by ±10° are applied in alternative arrangements. The orientation of the main directions of the three or multi-gradient transducers at a about 120° spacing permits the formation of the B-format.

Like the arrangement in which the capsules are arranged in a plane, the main directions of the transducers are inclined relative to each other by an azimuth angle φ (e.g., they are not only inclined relative to each other in a plane of the cone axis, but the projections of the main directions are also inclined relative to each other in a plane normal to the cone axis).

In the arrangement of FIG. 2, the acoustic centers of the three gradient transducers also lie within an imaginary sphere whose radius is equal to about double the largest dimension of the diaphragm of the transducer. By this spatial proximity of the acoustic centers, the coincidence that may form the B-format. As in the alternative to FIG. 1, the capsules shown in FIG. 2 are arranged on a boundary, for example or embedded within it.

In some acoustic transducer arrangements, there are shadowing effects that may restrict the range of use (for example, the employable frequency range). If the transducers are used in or on a boundary as described, the shadowing effects are substantially minimized or entirely eliminated.

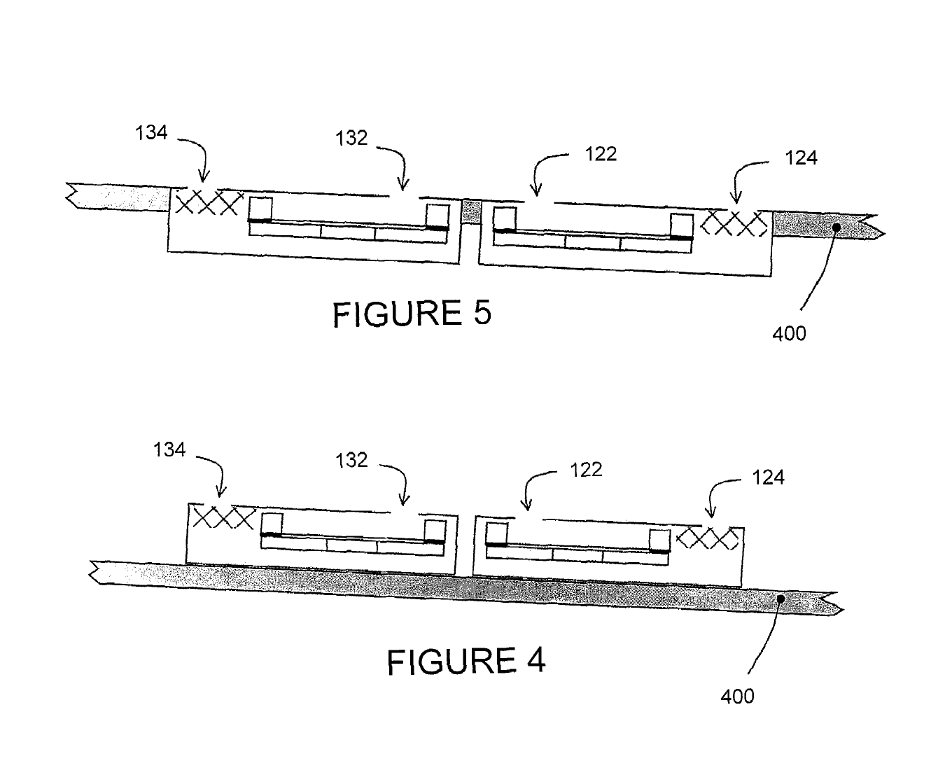

Boundary arrangements of capsules are shown in FIGS. 4 and 5. In FIG. 4, the capsules are positioned on boundary 400. In FIG. 5 they are embedded in boundary 400 substantially flush with the boundary.

FIG. 3 shows another alternative in which the pressure gradient capsules 100, 120, 130 are arranged within a common housing 300, in which the diaphragms, electrodes and mounts of the individual transducers are separated from each other by intermediate walls. The first sound inlet openings 102, 122, 132 that lead to the front of the diaphragm and the second sound inlet openings 104, 124, 134 that lead to the back of the diaphragm may no longer be seen from an outside view. The surface of the common housing 300, in which the sound inlet openings are arranged, (referring to the exemplary arrangement of FIG. 1) may be a plane or (referring to the exemplary arrangement of FIG. 2) a curved surface. The boundary may comprise a plate, console, wall, cladding, etc.

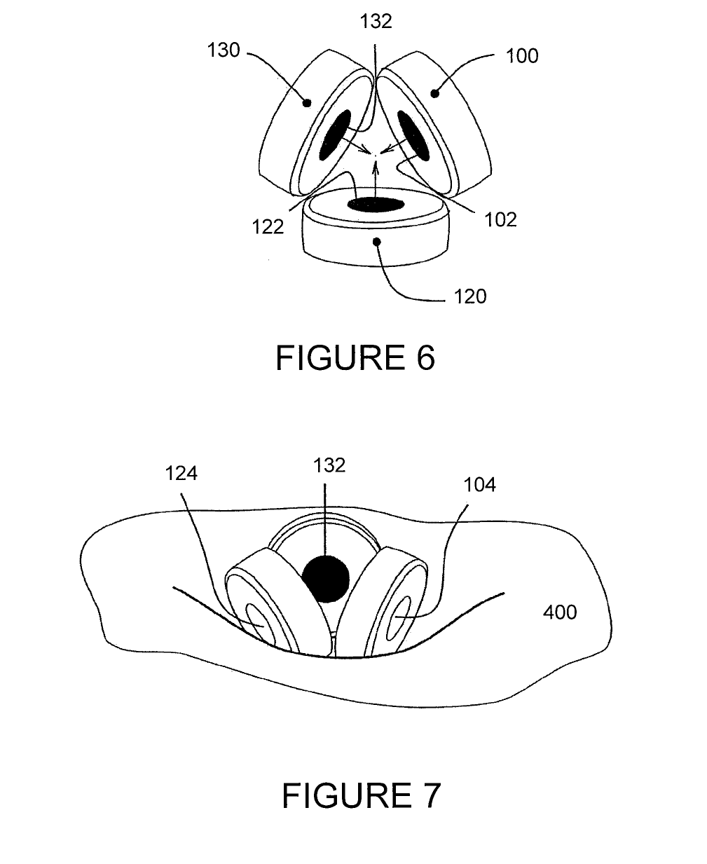

FIG. 6 shows another alternative arrangement that is constructed without a one-sided sound inlet microphone. In each of the pressure gradient transducers 100, 120, 130, the first sound inlet openings 102, 122, 132 are arranged on the front of the capsule housing and the second sound inlet openings 104, 124, 134 are arranged on the back of the capsule housing. The first sound inlet openings that lead to the front of the diaphragm face each other. They lie within an imaginary sphere whose radius is equal (or about equal) to about double the largest dimension of the diaphragm of a pressure gradient transducer. The main directions (shown as arrows in FIG. 6) of the three gradient transducers point to a common center area of the microphone arrangement. The projections of the main directions enclose an angle of about 120° from each other in a plane in which the first sound inlet openings 102, 122, 132 or their centers lie, as the base plane. Deviations of ±10° lie within the scope of these arrangements.

FIG. 7 shows an alternative in which the gradient capsules from FIG. 6 are embedded within a boundary 400. The sound inlet openings are not covered by the boundary 400.

In signal flow, the partial signals W, X, Y applied in an exemplary B-format may be formed from three capsule signals (e.g., only three). A set of signals, including an omni signal and at least two figure-eight signals, may be viewed in generalized manner as the B-format. The B-format may comprise an omni signal and at least two figure-eight signals. In some systems, the B-format includes an omni signal and two figure-eight signals. These partial signals are also referred to as a flat B-format.

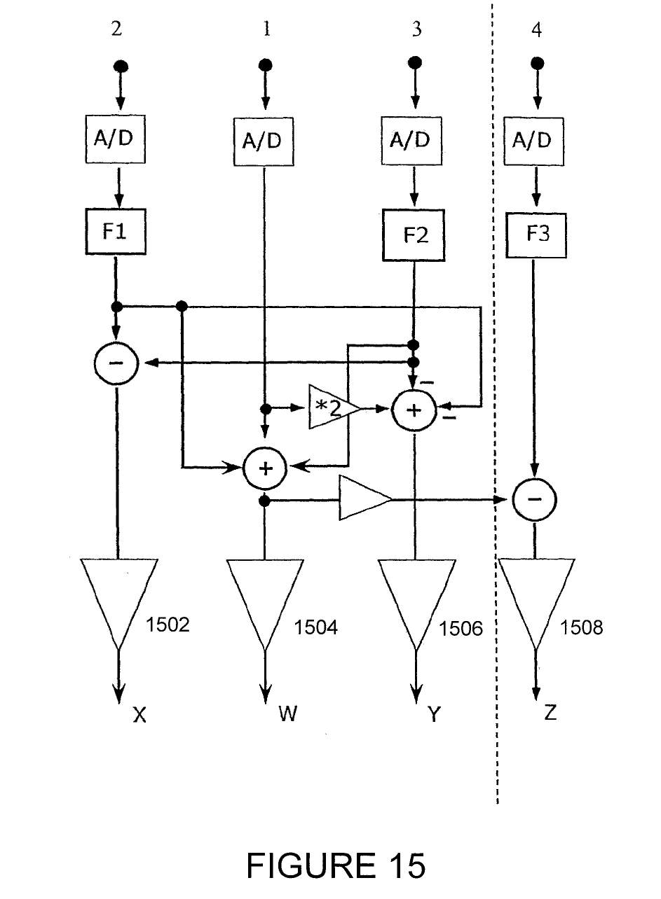

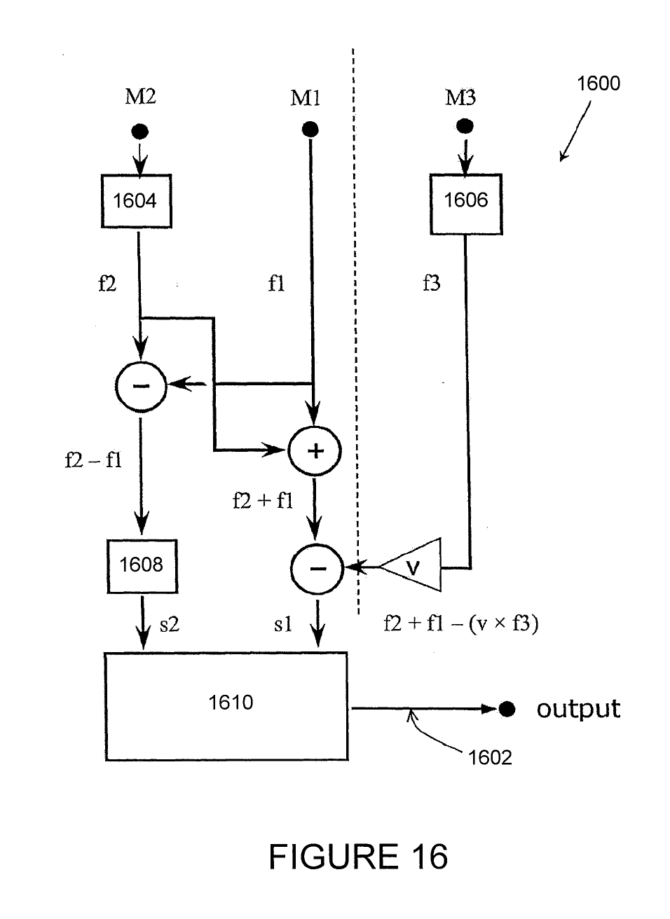

FIG. 15 shows how a flat B-format is formed from the individual capsule signals K1, K2 and K3 (the area separated by the dashed line with the capsule signal K4 is optional). The logic (and that shown in FIGS. 16-19) may be implemented though software (e.g., logic) stored on a computer readable storage medium and executed by a processor or circuits and hardware. The B-format includes an omni signal W, an X-component of the B-format, and a Y-component of the B-format. W, X, and Y may be described as:

W=K1+K2+K3

X=K2−K3

Y=(2×K1)−K2−K3

and may be implemented through software or by the circuit shown in FIG. 15. W is the omni signal and X and Y are the orthogonal figure-eight signals.

If normalization is applied, the B-format signals assume the following forms. The characteristics of each individual gradient capsule may be described by:

$$Kx = \frac{1}{a + b} ( a + b cos ( θ ) ) \qquad ( 1 )$$

in which a represents the weighting factor of the omni portion and b represents the weighting factor for the gradient portion. For values a=1, b=1, a cardioid is obtained; for values a=1 and b=3, a hypercardioid is obtained.

Three of the four B-format signals are derived with consideration of the directional characteristic normalized to 1 (or about 1):

$$\begin{matrix}W = \frac{( K 1 + K 2 + K 3 )}{3} * \frac{( a + b )}{a} & ( 2 ) \\ X = \frac{( K 2 - K 3 )}{\sqrt{3}} * \frac{( a + b )}{b} & ( 3 ) \\ Y = \frac{( 2 K 1 - K 2 - K 3 )}{3} * \frac{( a + b )}{b} & ( 4 )\end{matrix}$$

The directional characteristic of the employed gradient capsules is included in these formulas.

W represents the omni signal, which may be an omni directional signal. X and Y each represent a figure-eight lobe, whose axis of symmetry is parallel to the plane of the microphone. X and Y are substantially orthogonal to each other and are therefore inclined by 90° or about 90° relative to each other. By the combination of omni signal W with at least one of the figure-eight signals X, Y, any arbitrary directional characteristic may be generated. By the linear combination of X and Y with corresponding weighting factors, the figure-eight may be rotated within the x-y-plane. By the linear combination of this rotated figure-eight with the omni signal, the main direction of the synthesized signal may be rotated in different directions.

This linear combination may be written as the synthesized signal

M(q,r,s)=q×W+r×X+s×Y,

in which q, r, s represent the weighting factors, with which the B-format signals are incorporated in the final signal M.

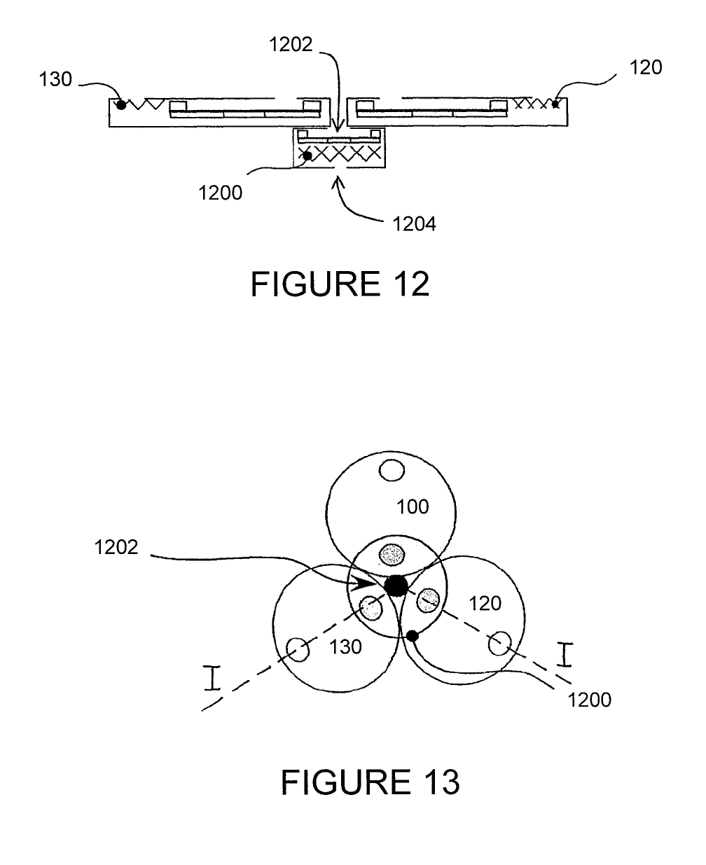

In FIG. 12, the microphone arrangement includes an additional gradient transducer 1200. The additional gradient transducer 1200 has a directional characteristic including at least one figure-eight portion. FIG. 12 shows an additional pressure gradient transducer 1200 in addition to the three pressure gradient transducers 100, 120, 130 (also called base pressure-gradient transducers for distinction), which is arranged centrally under the three base pressure-gradient transducers 100, 120, 130. 1202 denotes the first sound inlet opening, which leads to the front of the diaphragm, and 1204 represents the second sound inlet opening to the back of the diaphragm. Both sound inlet openings 1202 and 1204 lie in the axis of symmetry of the microphone arrangement. FIG. 13 shows the arrangement in the section along I-I. Additional fourth transducer may have a pure figure-eight characteristic K4=cos(θ), or may additionally include an ommi portion k. In the latter case, the signal of this gradient transducer may be represented by:

$$K 4 = k + ( 1 - k ) \times cos ( θ ) or again as$$

$$K 4 = \frac{1}{a + b} ( a + b cos ( θ ) ) .$$

The figure-eight portion is oriented so that the axis of symmetry 1402 of the figure-eight is substantially normal to the base plane (e.g., the plane that is spanned by the first three sound inlet openings of the pressure gradient transducers 100, 120, 130). Even if the additional pressure gradient capsule 1200 includes an omni portion, the main direction 1402 of the fourth capsule is essentially normal to the base plane. Through this fourth capsule, a complete B-format may be formed, comprising a sphere W and three orthogonal figure-eight signals X, Y, Z.

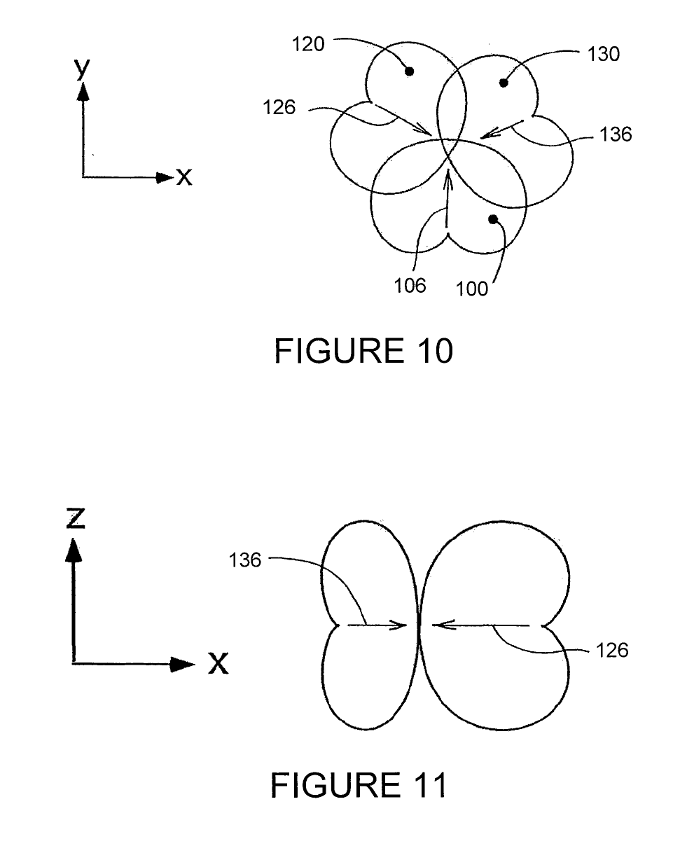

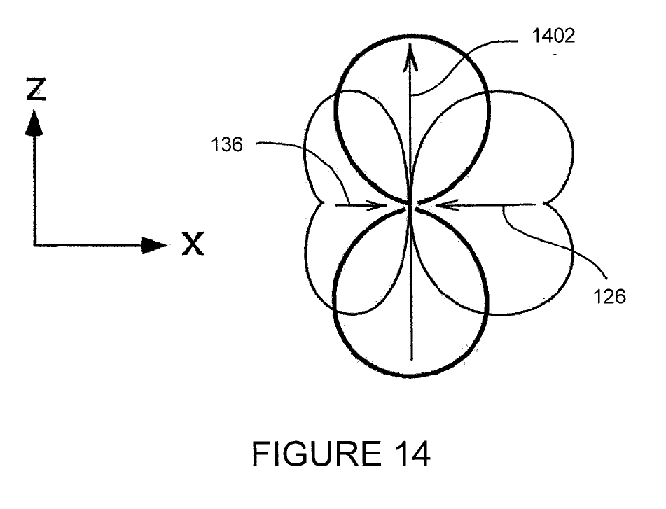

An additional pressure gradient capsule 1200 may also supplement the microphone arrangements shown in FIG. 1, FIG. 2, and FIG. 3, FIG. 6, and FIG. 7. Orientation of the individual directional characteristics may be deduced from FIGS. 10, 11 and 14, in which FIGS. 10 and 11 show the case with three capsules and FIG. 14 shows the case with the additional capsule 1200. When an additional pressure gradient capsule is used, the rear sound inlet should not be covered, (e.g., that the entire capsule arrangement may not be arranged in a boundary).

FIG. 15 shows a block diagram to produce the B-format signals. The signals of the individual transducers are digitized by A/D transducers and the frequency responses of the individual transducers are equalized with respect to each other through filters F1, F2 and F3. By corresponding summations and subtractions, as well as multiplications, the signals are modified according to the equations for the B-format and weighted or normalized through amplifiers 1502, 1504, 1506, and 1508, so that normalized B-format signals X, W, Y, Z are formed according to the above formulas.

The optionally contained omni portion k of signal K4 may be compensated by the omni signal W already obtained from the three capsules 100, 120, 130 by filtering the microphone signal K4 through linear filter unit F3, so that after selective signals pass, during sound exposure from any direction in the x-y-plane, the same signal as the W signal is formed after the signal passes through filter F3. The omni signal is derived by measuring the impulse response from a direction across the main direction of the gradient transducer K4.

Because of this process, during subtraction Z=K4 (filtered with F3)−W, a pure gradient signal with a figure-eight characteristic is left, whose axis of symmetry is substantially normal to that of signals X and Y. This gradient signal is in the z-direction, which is substantially normal to the boundary (if this is a plane). The gradient signal Z may be adjusted by linear filtering in its properties to the frequency response and sensitivity of the X- and Y-signals. Like the response of a soundfield microphone, four B-format signals that may be arbitrarily combined are obtained. The expression may therefore read:

M(q,r,s,t)=q×W+r×X+s×Y+t×Z.

The areas of application of such a soundfield microphone are many and extend to use in a vehicle, aircraft, for recording of music, conferences, etc. Other details of these microphones are in U.S. Pat. No. 4,042,779 A (and the corresponding DE 25 31 161 C1), the disclosures of which are incorporated by reference.

Synthesized microphone signals M1, M2, and optionally M3, may be derived according to the formula:

M(q,r,s)=q×W+r×X+s×Y

or

M(q,r,s,t)=q×W+r×X+s×Y+t×Z.

The synthesized signals M1, M2 and M3 now have directional characteristics. These are cardioids, having main directions that lie in one plane and are inclined with respect to each other by about 120°.

FIG. 16 is a block diagram receiving inputs, at which the synthesized signals M1 and M2 lie, and shows the output 1602 of the signal processing unit 1600. The synthesized signals are digitized with A/D converters (not shown). Subsequently, the frequency responses of the synthesized signals are compared to each other and adjusted, to compensate for manufacturing tolerances of the individual capsules. This occurs by linear filters 1604 and 1606 which adjust the frequency responses of the synthesized signals M2 and M3 to those of synthesized signal M1. The filter coefficients of linear filters 1604 and 1606 are determined from the impulse responses of the participating gradient transducers, with the impulse responses being measured from an angle of about 0° in the main direction. An impulse response is the output signal of a transducer, when it is exposed to a narrowly limited acoustic pulse in time. When determining the filter coefficients, the impulse responses of transducers 120 and 130 are compared with that of transducer 100. In FIG. 10 the impulse responses of all gradient transducers 100, 120, and 130 after passing through the filter, have the same frequency response. This arrangement serves to compensate for deviations in the properties of the individual capsules.

In FIG. 16 a sum signal f1+f2 and a difference signal f1−f2 are formed from the filter signals f1 and f2 that result from M1 and M2 by filtering. The sum signal is dependent on the directional characteristic and its orientation in space, and therefore dependent on the angle of the main directions of the individual signals M1, M2 relative to each other, and contains a more or less large omni portion.

At least one of the two signals f1+f2 or f2−f1 is processed in another linear filter 1608. This filtering adjusts the two signals to each other, so that the subtraction signal f2−f1 and the sum signal f1+f2, which have an omni portion, have a maximum agreement when overlapped. The subtraction signal f2−f1, which has a figure-eight directional characteristic, is inflated or contracted in filter 1608 as a function of the frequency, so that maximum rejection in the resulting signal occurs when it is subtracted from the sum signal. The adjustment in filter 1606 occurs for each frequency and each frequency range separately.

Determining the filter coefficients of filters 1606 may also occurs through an impulse responses of the individual transducers. Filtering of the subtraction signal f2−f1 renders signal s2; the (optionally filtered) summation signal f1+f2—in an exemplary two synthesized signal arrangement M1, M2—renders signal s1 (the optional portion of the signal processing unit 1600, shown on the right side of the dashed separation line, may not be present during use of only two signals M1, M2).

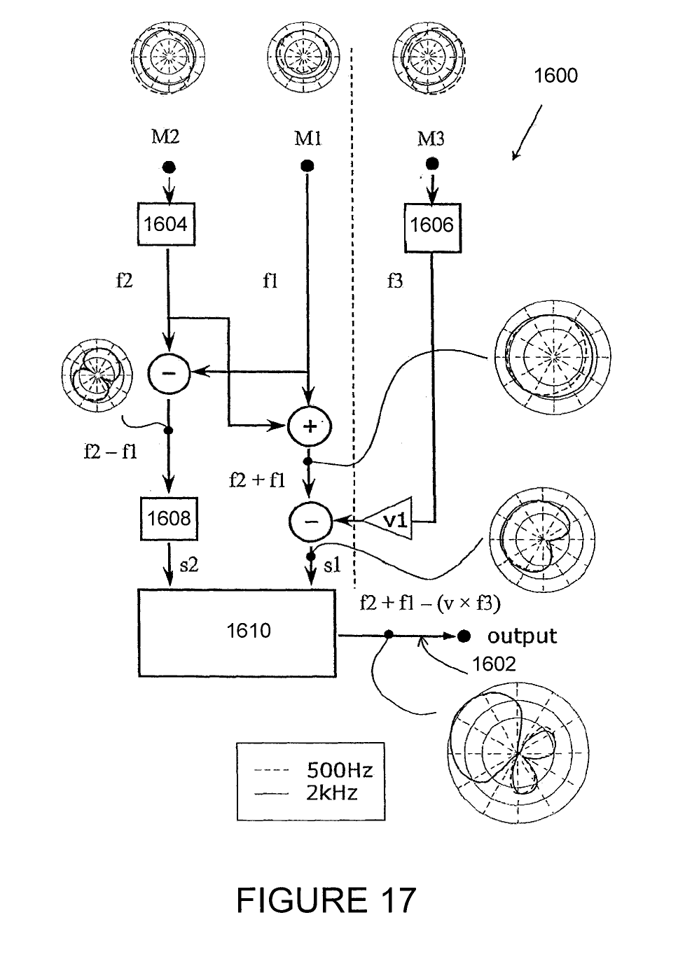

However, three synthesized signals M1, M2, M3 may be processed in signal processing (to the right of the separation line in FIG. 17). The signal f3, made substantially equal to the frequency response of signal M1 in linear filter 1606, is multiplied by amplification factor v and subtracted as v×f2 from the sum signal f1+f2. The resulting signal s1 corresponds to (f1+f2)−(v×f2), in the case of three signals.

The amplification factor v, in which direction the useful direction may lie, (e.g., that spatial direction) may be limited by the directional characteristic of the total synthesized signal. In some applications, the possible useful directions are unrestricted, because the synthesis signals M1, M2 and M3 may be arbitrarily rotated. For example, if factor v is very small, the effect of the third synthesis signal M3 on the total signal is limited and the sum signal f1+f2 dominates relative to signal v×f3. If the amplification factor v is negative and large, the individual signal v×f3 dominates over the sum signal f1+f2 and the useful sound direction or the direction in which the synthesized total signal directs its sensitivity. Therefore, the signal rotated by about 180° with reference to the former case. By variation of factor v, this arrangement permits a change in sum signals, so that an arbitrary directional characteristic is generated in the desired direction.

This bundling mechanism may be applied to all signal combinations. For the direction to which bundling to occur an intrinsic spectral subtraction block may be used. The signal processing acts occurring before the spectral subtraction block may be combined to the extent that only factor v need be different for two opposite directions. The other preceding acts and branches remain the same for these two directions.

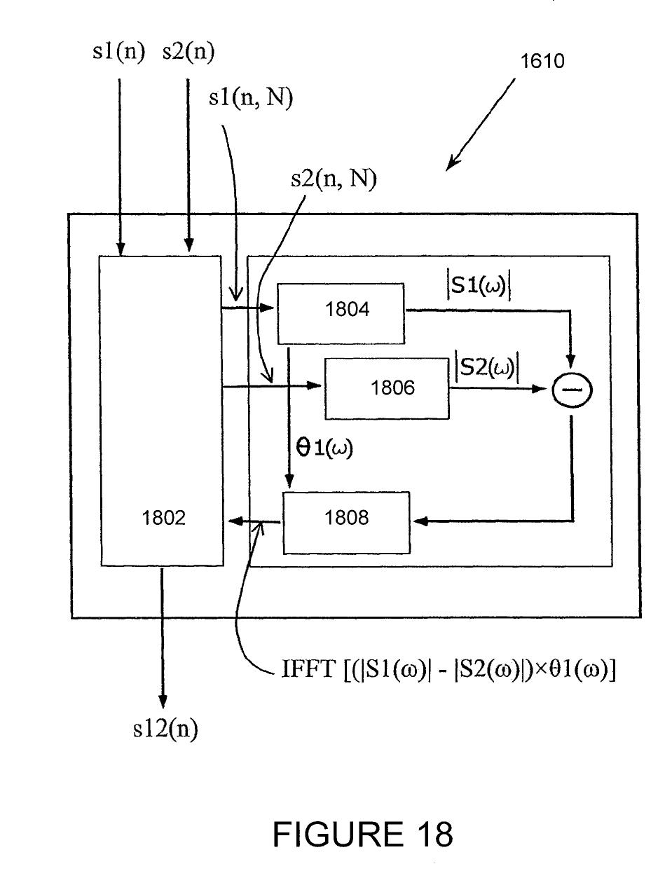

The spectral subtraction applied to the two intermediate signals s1 and s2 and occurs in block 1610. FIG. 18 shows individual components of a spectral subtraction block 1610 in detail and pertain to calculation at the digital level. The A/D conversion of the signals occurs before spectral subtraction block 1610 and the filtering and signal combinations conducted before this occurs on the analog plane.

Two signals s1(n) and s2(n) serve as the input of block 1610 in the time range derived from the signals that were recorded at the same time and at the same point (or at least in the immediate vicinity). This ensures the coincident arrangement of transducers 100, 120, and 130; s1(n) represents the signal that has the most useful signal portions, whereas s2(n) represents the signal that contains more interference signals, in which signal s2(n) is characterized by the fact that it has a zero-position, in the viewing of the polar diagram, in the useful sound direction; n represents the sample index and s(n) therefore corresponds to a signal in the desired time range.

The unit 1802 generates individual blocks with a block length N=L+(M−1) from the continuously arriving samples. L represents the number of new data samples in the corresponding block. The remainder (M−1) of samples was found in the preceding block. This method is an overlap and save method.

The N samples contained in a block are conveyed to unit 1804 at the times at which M−1 samples have reached unit 1802 since the preceding block. The processing of unit 1804 occurs in a block-oriented manner. The signal s1(n, N) packed into blocks reaches unit 1804, unit 1806 receives signal s2(n, N) packed into blocks in a format or protocol.

In units 1804 and 1806, the end samples of signals s1 and s2 that are combined are transformed by FFT (fast Fourier transformation), for example, DFT (discrete Fourier transformation), into the frequency range. The signals S1(ω) and S2(ω) are broken into magnitude and phase, so that the magnitude value signals |S1(ω)| and |S2(ω)| occur at the output of units 1804 and 1806. By spectral subtraction, the two value signals are subtracted and produce (|S1(ω)|−|S2(ω)|).

The resulting signal (|S1(ω)|−|S2(ω)|) is then transformed to the time domain. For this purpose, the phase Θ1(ω), which was separated in unit 1804 from signal S1(ω)=|S1(ω)|×Θ(ω) and which, like the value signal |S1(ω)|, also has a length of N samples, is used during the time domain transformation. The time domain transformation (or back-transformation) occurs in unit 1808 through an IFFT device (inverse fast Fourier transformation), for example, IDFT (inverse discrete Fourier transformation) and is carried out based on the phase signal Θ1(ω) of S1(ω). The output signal of unit 1808 may be represented as IFFT [(|S1(ω)|−|S2(ω)|)×exp(Θ1(ω)]. The generated N samples of long digital time signal S12(n, N) is transmitted to processing unit 1802, where it is incorporated in the output data stream S12(n) according to an overlap and save method.

The parameters obtained in this method are block length N and rate (M−1)/fs [s] (with sampling frequency fs), with which the calculation or generation of a new block is initiated. In any individual sample, an entire calculation may be carried out. In some conditions, about 50 ms has proven useful as the value for the block length and about 200 Hz as the repetition rate, in which the generation of a new block is initiated.

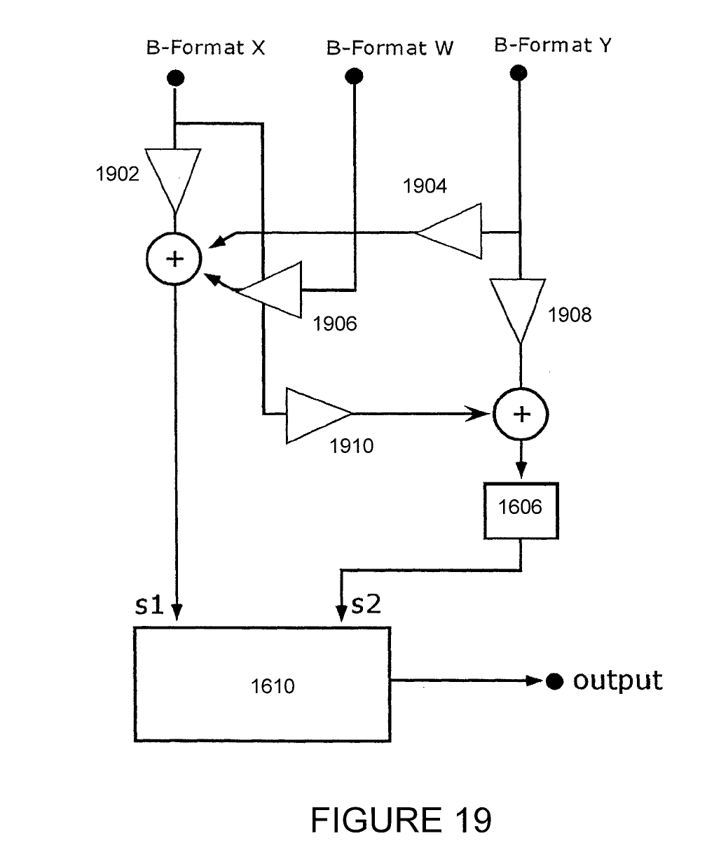

The signal processing described in (FIGS. 16 and 17), in which a signal narrowly bundled in a specific direction may be produced, starting from B-format signals, may be implemented in an alternative. FIG. 19 shows a corresponding circuit for three B-format signals W, X, Y to the synthesized signals s1 and s2. The subsequent spectral subtraction block 1610 remains. The amplifiers 1902 to 1910 weigh the individual B-format signals according to the direction in which one intends to direct a narrow lobe of the directional characteristic. The filter 1606 ensures that during the spectral subtraction of signal s1 from s2, the resulting signal s12 has minimal energy. The phase of signal s1, which also contains onmi portion (W), is processed to provide the subtracted signal with this phase. This preserves the original character of the useful signal. A common feature of FIGS. 16 and 17 and FIG. 19 is the attempt to generate s1 that has an omni portion W, in addition to figure-eight portions X and Y, and a pure figure-eight signal s2.

The synthesized output signals s12(n) contain phase information from the special directions that point to the useful sound source, or are bundled on it. S1, whose phase is used, is the signal that has increasing useful signal portions, in contrast to s2. Through this analysis, the useful signal is not distorted and retains its original sound.

FIG. 17 shows the synthesized directional characteristics of the individual combined signals M1, M2, M3 and the intermediate signals, in which the amplitudes are in each case normalized to the useful sound direction designated with about 0°, (e.g., all the polar curves and those during sound exposure from about a 0° direction are normalized to about 0 dB). The output signal 1602 has a directional characteristic bundled particularly strongly in one direction.

Other alternate systems and methods may include combinations of some or all of the structure and functions described above or shown in one or more or each of the Figures. These systems or methods are formed from any combination of structure and function described or illustrated within the figures. Some alternative systems or devices compliant with one or more of the transceiver protocols may communicate with one or more in-vehicle or out of vehicle receivers, devices or displays.

The methods and descriptions of FIGS. 15-19 may be programmed in one or more controllers, devices, processors (e.g., signal processors). The processors may comprise one or more central processing units that supervise the sequence of micro-operations that execute the instruction code and data coming from memory (e.g., computer memory) that generate, support, and/or complete a compression or signal modifications. The dedicated applications may support and define the functions of the special purpose processor or general purpose processor that is customized by instruction code (and in some applications may be resident to vehicles). In some systems, a front-end processor may perform the complementary tasks of gathering data for a processor or program to work with, and for making the data and results available to other processors, controllers, or devices.

The methods and descriptions may also be programmed between one or more signal processors or may be encoded in a signal bearing storage medium a computer-readable medium, or may comprise logic stored in a memory that may be accessible through an interface and is executable by one or more processors. Some signal-bearing storage medium or computer-readable medium comprise a memory that is unitary or separate from a device, programmed within a device, such as one or more integrated circuits, or retained in memory and/or processed by a controller or a computer. If the descriptions or methods are performed by software, the software or logic may reside in a memory resident to or interfaced to one or more processors or controllers that may support a tangible or visual communication interface, wireless communication interface, or a wireless system.

The memory may include an ordered listing of executable instructions for implementing logical functions. A logical function may be implemented through digital circuitry, through source code, or through analog circuitry. The software may be embodied in any computer-readable medium or signal-bearing medium, for use by, or in connection with, an instruction executable system, apparatus, and device, resident to system that may maintain persistent or non-persistent connections. Such a system may include a computer-based system, a processor-containing system, or another system that includes an input and output interface that may communicate with a publicly accessible distributed network through a wireless or tangible communication bus through a public and/or proprietary protocol.

A “computer-readable storage medium,” “machine-readable medium,” “propagated-signal” medium, and/or “signal-bearing medium” may comprise any medium that contains, stores, communicates, propagates, or transports software or data for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection having one or more wires, a portable magnetic or optical disk, a volatile memory, such as a Random Access Memory (RAM), a Read-Only Memory (ROM), an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A microphone arrangement that includes at least two transducers comprising:
a plurality of pressure gradient transducers having diaphragms, a directional characteristic of each of the plurality of pressure gradient transducer comprising an omni portion and a figure-eight portion and having a direction of maximum sensitivity in a main direction, each main direction of the plurality of pressure gradient transducers are inclined relative to each other;
a plurality of first sound inlet openings leading to a front of the diaphragms;
a plurality of second sound inlet openings leading to the back of the diaphragms;
acoustic centers of the plurality of pressure gradient transducers lying within an imaginary sphere whose radius corresponds to about double of a largest dimension of the diaphragms of the plurality of pressure gradient transducer; and
a plurality of projections of the main directions of the plurality of pressure gradient transducers project into a base plane spanned by the plurality of first sound inlet openings of the plurality of pressure gradient transducers that enclose an angle between about 110° and abut 130° with respect to each other.

2. The microphone arrangement of claim 1 where the acoustic centers of the pressure gradient transducers lie within an imaginary sphere whose radius corresponds to the largest dimension of the diaphragm of the plurality of transducers.

3. The microphone arrangement of claim 1 where the plurality of projections of the main directions of the plurality of pressure gradient transducers enclose an angle of about 120° with each other in a plane in which the plurality of first sound inlet openings lie.

4. The microphone arrangement of claim 1 where the plurality of pressure gradient transducers are positioned within a boundary.

5. The microphone arrangement of claim 1 where each of the plurality of pressure gradient transducers, the first sound inlet openings, and the second sound inlet openings are arranged on a common side of a housing.

6. The microphone arrangement of claim 3 where the front sides of the plurality of pressure gradient transducers are positioned flush with a boundary.

7. The microphone arrangement of claim 1 where each of the pressure gradient transducers, the first sound inlet openings are positioned on the front of a capsule housing and the second sound inlet openings are positioned on the back of the capsule housing.

8. The microphone arrangement of claim 1 where the plurality of pressure gradient transducers lie against one of a plurality of lateral surfaces of an imaginary equilateral triangular prism.

9. The microphone arrangement of claim 1 where the plurality of pressure gradient transducers lie against one of a plurality of lateral surfaces of an imaginary regular pyramid having an equilateral triangular base.

10. The microphone arrangement of claim 1 where the plurality of pressure gradient transducers are arranged in a common capsule housing.

11. The microphone arrangement according to claim 1 where the plurality of pressure gradient transducers comprises four transducers in which one of the four transducers lies within the imaginary sphere in which the acoustic centers of the other pressure gradient transducers also lie; and that a main direction of one of the four pressure gradient transducer lies essentially normal to the base plane.

12. The microphone arrangement according to claim 11 where at least one of the plurality of pressure gradient transducers has a figure-eight characteristic.

13. A method of synthesizing one or more microphone signals from a microphone arrangement comprising:
providing a plurality of pressure gradient transducers having diaphragms, a directional characteristic of each of the plurality of pressure gradient transducers comprising an omni portion and a figure-eight portion and having a direction of maximum sensitivity in a main direction, each main direction of the plurality of pressure gradient transducers are inclined relative to each other;
providing a plurality of first sound inlet openings leading to a front of the diaphragms and a plurality of second sound inlet openings leading to the back of the diaphragms;
providing acoustic centers of the plurality of pressure gradient transducers lying within an imaginary sphere whose radius corresponds to about double of a largest dimension of the diaphragms of the plurality of pressure gradient transducers;
providing a plurality of projections of the main directions of the plurality of pressure gradient transducers project into a base plane spanned by the plurality of first sound inlet openings of the plurality of pressure gradient transducers that enclose an angle with respect to each other; and
generating a B-format that comprises an omni signal and two figure-eight signals that are substantially orthogonal to each other.

14. The method of claim 13 the act of generating the B-format signal is based on an output of four pressure gradient transducers and comprises an omni signal and three figure-eight signals that are substantially orthogonal to each other.

15. The method of claim 14 where B-format signals (W, X, Y) and omni signal (W) are based on the following form:
$$W = \frac{( K 1 + K 2 + K 3 )}{3} * \frac{( a + b )}{a} , \\ X = \frac{( K 2 - K 3 )}{\sqrt{3}} * \frac{( a + b )}{b} , \\ Y = \frac{( 2 K 1 - K 2 - K 3 )}{3} * \frac{( a + b )}{b} ,$$
in which a represents the weighting factor for the omni portion and b the weighting factor for the figure-eight portion of signals of three pressure gradient capsules, in which signals can be described by the expression:
$$Kx = \frac{1}{a + b} ( a + b cos ( ϕ ) ) .$$

16. The method of claim 13 where a first signal and a second signal is synthesized from the B-format, the first signal containing an omni portion and at least one figure-eight portion, and the second signal containing at least one figure-eight portion; where each of the first signal and the second signal are transformed into the frequency domain and are subtracted from each other, independent of their phases.

17. The method of claim 16 where the frequency responses of the B-format signals are equalized before formation of the synthesized signals.

18. A microphone arrangement comprising:
a plurality of pressure gradient transducers having diaphragms, a directional characteristic of each of the plurality of pressure gradient transducer comprising an omni portion and a figure-eight portion and having a direction of maximum sensitivity in a main direction, each main direction of the plurality of pressure gradient transducers are inclined relative to each other;
a plurality of first sound inlet openings leading to a front of the diaphragms;
a plurality of second sound inlet openings leading to the back of the diaphragms;
acoustic centers of the plurality of pressure gradient transducers lying within an imaginary sphere whose radius corresponds to about double of a largest dimension of the diaphragms of the plurality of pressure gradient transducer; and
a plurality of projections of the main directions of the plurality of pressure gradient transducers project into a base plane spanned by the plurality of first sound inlet openings of the plurality of pressure gradient transducers that enclose an angle between about 110° and abut 130° with respect to each other
where the plurality of pressure gradient transducers comprises at least three pressure gradient transducers.
